(19) United States
(12) Patent Application Publication
(10) Pub. No.: US 2016/0258778 A1
(43) Pub. Date: Sep. 8, 2016

(54) METHOD FOR CALIBRATING THE PHYSICAL POSITION AND ORIENTATION OF AN ELECTRONIC DEVICE USING DEVICE SENSORS ONLY

(71) Applicant: IMSI DESIGN, LLC, Novato, CA (US)

(72) Inventors: Douglas R. Cochran, Novato, CA (US); Kevan Chapman, Tulsa, OK (US); Robert Mayer, Larkspur, CA (US); Royal Farros, Woodside, CA (US); Konstantin Yarkoev, Sunnyvale, CA (US)

(21) Appl. No.: 15/028,704

(22) PCT Filed: Oct. 14, 2014
(86) PCT No.: PCT/US14/60537

§ 371 Date: Apr. 11, 2016

Related U.S. Application Data
(60) Provisional application No. 61/890,132, filed on Oct. 11, 2013.

(51) Int. Cl. G01C 22/00; G01C 21/16

(52) U.S. Cl. CPC G01C 22/006; G01C 21/165

(57) ABSTRACT

A sensor position system that includes a portable programmable electronic device having a visual display screen and at least one motion sensor; and an executable sensor position system program loaded onto said electronic device, said program including executable instructions which visually display a two- or three-dimensional virtual representation of a user-selected physical space on the electronic visual display, enable a user to mark an initial reference point in the displayed virtual representation of the physical space, receive a data signal from said at least one motion sensor, evaluate the data signal from said at least one motion sensor so as to distinguish walking and running movements from other movements.

### BACKGROUND OF THE INVENTION

1. Technical Field

The present invention relates generally to position location devices, and more particularly to apparatus and method for calibrating a physical location using device sensors, and still more particularly to a sensor position system for calculating and presenting a position in a 2D or 3D spatial representation on an electronic device using the device sensors only.

2. Background Art

It is helpful to display a physical position calibrated in a 2D or 3D spatial representation on an electronic device when data from other forms of electronic positioning, such as but not limited to GPS (Global Positioning System), A-GPS (Assisted Global Positioning System), and WPS (Wi-Fi Positioning System), are not available. As an example: when performing an indoor building inspection at a remote location, it is helpful to have the inspector's current location and orientation accurately indicated on an electronic drawing. However, because GPS signals are blocked by buildings, terrain, and even dense foliage or cloud cover, satellite GPS does not work indoors, and if a building is too remote, cellular and Wi-Fi data may not be available. Using the method of the present invention, data from electronic device sensors, including but not limited to accelerometers, gyroscopes, magnetometers, pedometers, compasses, barometers, and/or motion sensors, and/or the ability to manually fine-tune a position and/or orientation, combined with an electronic display, perform such positional calibration without the assistance of other forms of electronic positioning systems.

### DISCLOSURE OF INVENTION

The present invention is a computer-implemented sensor position system and method for indicating the current physical position and orientation of a portable electronic device (and by extension, the position of a user holding the device) on the visual display of the electronic device without assistance from GPS, A-GPS, WPS, or other forms of electronic positioning systems external to the electronic device. The system includes a computer-executable program operated on a portable electronic device with an electronic visual display showing a representation (a drawing) of the physical space. In use, the user selects an initial reference location (a starting point) and moves in one direction to define a second reference location (a new, end position), thereby creating calibration points in the visually displayed virtual physical space. The points indicated in the display therefore correspond to physical locations in the actual physical space. From these initially selected calibration points, the device gathers positional data from device sensors as the device is moved to each reference location. The data is used to determine the position and/or orientation of the device in a 2D or 3D spatial representation on the device display.

There are three main challenges in accurately navigating using device sensors only: first, the system must be able to differentiate user activities detectable by device sensors (i.e., a device state must be determined) such as whether the user is walking with the device, tapping the device (for instance, by typing), simply standing, fidgeting, shaking, running, etc.; second, the system must be able to determine the particular user's stride length; and, third, the system must determine the direction in which the user is moving, both horizontally and vertically.

The present invention is a sensor position system and method to solve all three of these problems, and thereby provides a way to navigate and to represent position within a defined area or structure.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a highly simplified data flow diagram of a first stage of the device state determination method employed in the present invention, and, specifically, a pre-processing stage;

FIG. 2 is a graph illustrating filtered sensor data and dynamic threshold;

FIG. 3 is a data flow diagram of a second stage in the device state determination method employed in the present invention, this stage involving a potential step determination;

FIG. 4 is a data flow diagram showing a third stage in the device state determination, this stage involving of pattern matching;

FIG. 5 is an empirical formula for distance between curves;

FIG. 6 is a graph showing the wave form and “trembling” caused by a user's heel strike;

FIG. 7 is a graph showing use of a band-pass filter to determine actual steps;

FIG. 8A is a graph showing a waveform for a series of steps;

FIG. 8B is a graph showing a waveform for a series of irregular movements, such as the bouncing or shaking of a leg in a sitting position;

FIG. 9A is a graph illustrating the passband of the signal of FIG. 8A after band-pass filtering and frequency analysis;

FIG. 9B is a graph illustrating the passband of the signal of FIG. 8B after band-pass filtering and frequency analysis;

FIG. 10 is an empirical formula for distance between sequences;

FIG. 11 illustrates the stride length determination;

FIG. 12 is an empirical formula for stride length determination;

FIG. 13 illustrates difference device orientations;

FIG. 14 shows that the start angle depends on orientation;

FIG. 15 shows a formula for vector of movement;

FIG. 16 is a position determination equation;

FIG. 17A schematically illustrates an actual route traveled by a system user;

FIG. 17B schematically shows accumulated errors in the sensor positioning system that lead to an erroneous position indication; and

FIG. 18 schematically illustrates the corrected position from FIG. 17B by using a magnetometer.

### BEST MODE FOR CARRYING OUT THE INVENTION

The method and system of the present invention solves three primary problems in providing a position indication on an electronic device using device sensors only. First, the system provides means to differentiate user movements that are detectable by device motion and position sensors. For instance, accelerometers, magnetometers, compasses, gyroscopes, and the like, may respond to nearly any kind of movement, even if the movement does not appreciably change the user's position. Accordingly, a device state must first be determined. That is to say, the system must determine whether the user is walking, typing on the device or making other inputs by tapping the device touchscreen, whether the user is standing idle and still or fidgeting, shaking, running, or otherwise moving through space. The system next provides a way to accurately determine the user's stride length. Finally, the system calculates the distance and the direction in which the user is moving.

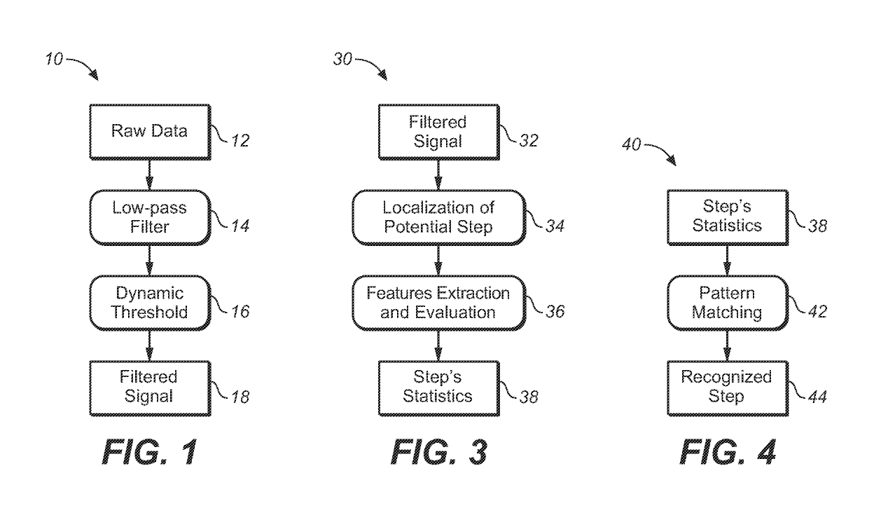

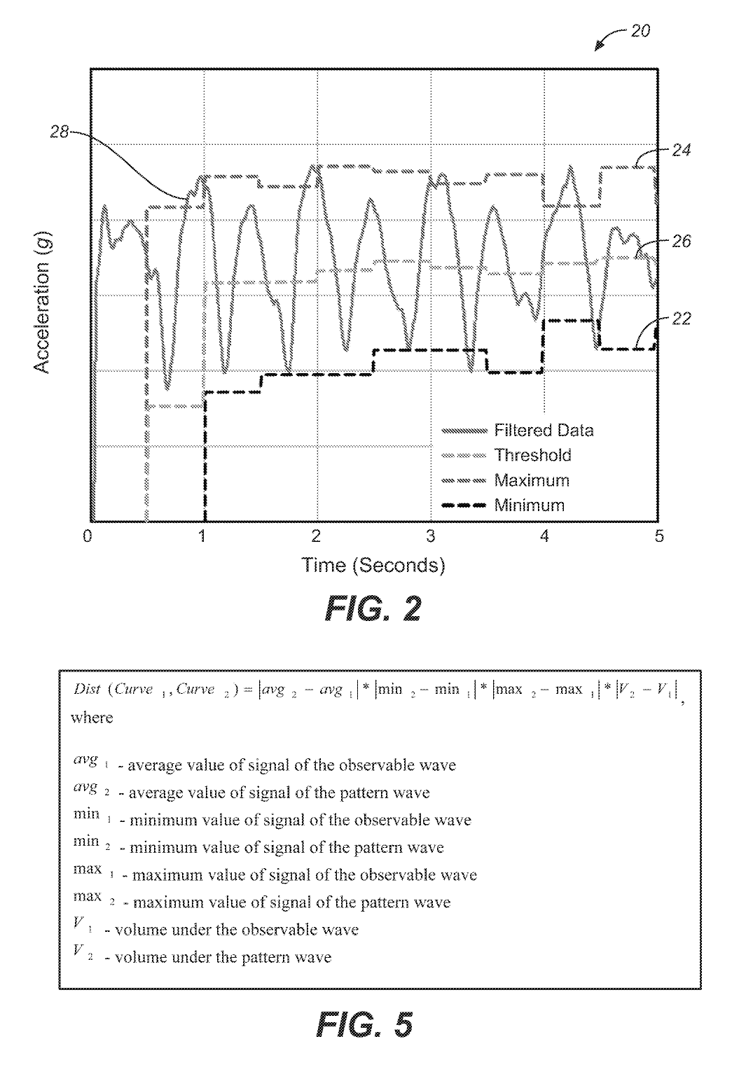

Referring first to FIG. 1, there is shown in a flow diagram a first, pre-processing, stage 10 in the device state determination. This involves the use of a motion-based sensor positioning system (“SPS”). The program receives raw data 12 from a sensor, such as an accelerometer, gyroscope, magnetometer, or other position, motion, and/or orientation sensor. Since most of the useful information associated with human movements is below 3 Hz, the system employs a low-pass filter 14, but it may also utilize a high-pass filter with a cutoff frequency of 1 Hz to remove gross orientation changes. However, walking is not an entirely smooth motion and by itself includes myriad sharp jostling motions detectable by motion sensors. Thus, when holding a portable device, a user's heel strikes may cause an accelerometer to detect a wave having a maximum amplitude (see FIG. 2). Most other walking motions do not produce waves with such amplitude. In consequence, the inventive system uses a combination of a constant threshold and a dynamic threshold 16 to produce a filtered signal: the constant threshold is a barrier used to filter out signals with low amplitude; the dynamic threshold is an adaptive barrier responsive to raw data from the sensors passing the constant thresholds for relatively powerful movements characteristic of walking and running motions.

FIG. 2 is a graph 20 showing how the dynamic threshold 28 is derived from minimum and maximum thresholds 22, 24 employed to generate a filtered signal 26, a wave form for the filtered raw data (ref. no. 12 in FIG. 1).

Referring now to FIG. 3, the second stage 30 in the state determination made by the present invention involves a potential step determination using the filtered signal 32, shown in FIG. 2 as reference number 26. As used herein, “potential step” means an acceleration detected by one or more on-board device sensors that may be a user's step but which has not, as yet, been analyzed to determine whether it possesses the characteristics of an actual step. The system first localizes the potential step 34 by identifying waves that may signify a walking or running step. This is accomplished first by taking a wave peak that is potentially a heel strike. The system then locates the left and right borders of the wave and each wave peak (see FIG. 2).

Next, and referring again to FIG. 3, at block 36 the system extracts the meaningful parameters of one wave: min value, max value, mean value, integral (area under the curve), and width of wave and saves them as step statistics 38.

Looking now at FIGS. 4 and 5, the system next compares different wave patterns and step statistics and employs an empirical distance function based on the step statistics calculated and saved in the previous step. Next, in a pattern matching step 42, the distance between the observed data from the sensors and the pattern wave is calculated and compared using the equation 50 of FIG. 5, and a decision/determination is made as to whether the potential step is a recognized step 44.

Next, steps are filtered using a selected threshold. The selection is empirically determined: if too a low threshold is employed, the system will fail to recognize similar curves/motions; if too high a threshold is employed, it will treat non-walking motions (e.g., shaking, tapping, etc.) as walking motion. Accordingly, a sensitivity feature is provided in the user interface so that users may tune the threshold. The system also includes three pre-recorded patterns for a heavy-, medium-, and lightweight human. The user can also record his/her personal pattern (see FIG. 5).

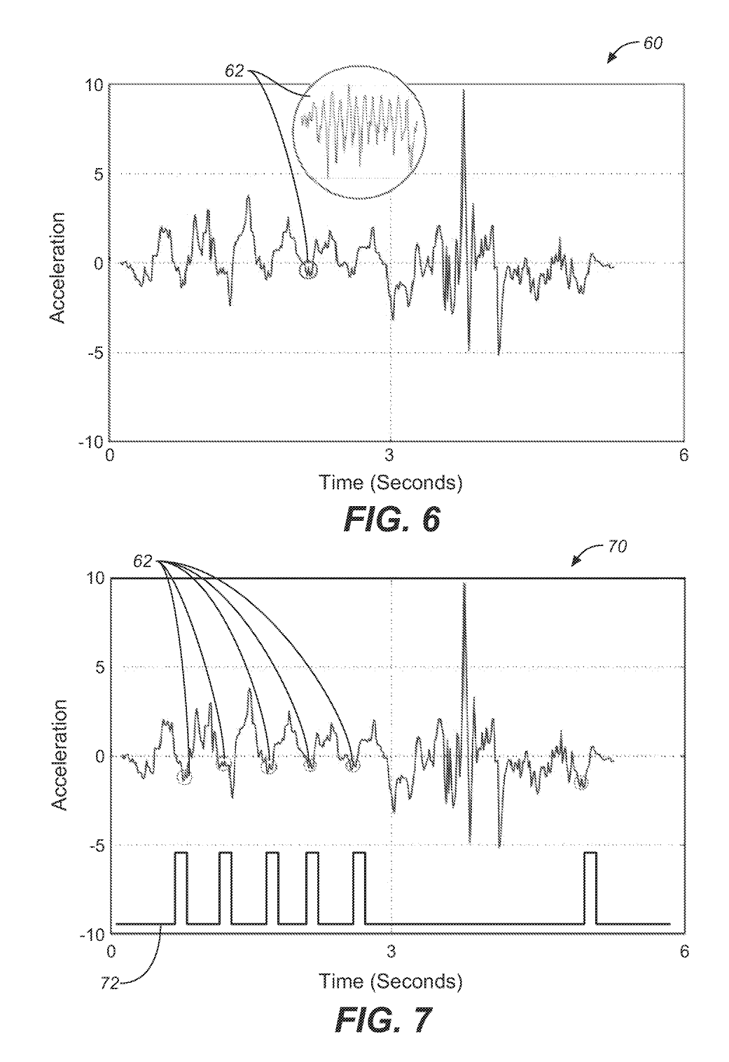

FIG. 6 is a graph 60 showing a broad range of signals including a band 62 characteristic of a user's heel strike. When the heel contacts the surface it produces high-frequency trembling around 30-40 Hz (see FIG. 6). Then, and referring next to FIG. 7 (a graph showing the signals of FIG. 6 to which a band pass filter is applied to produce a pass band 72), by applying a band-pass filter and sensor positioning system algorithm to filter and separate the particular “trembling” band of frequencies 62 characteristic of heel strikes from the broader range of mixed signals, false (non-actual) step motions can be distinguished from true steps and the step determination made (see FIG. 7).

In the pattern matching discussed at paragraph [0035] the system localizes each step and then compares it to the pattern step using the distance function of FIG. 5. This leads to a “local observer” problem when an observer cannot see the entire scene; this is because walking and other movements can produce nearly the same values for the device because the user holds is holding it in his/her hands. Testing has shown that the best mount position for a pedometer is near the heel of the user. Mounting on the belt is inferior due to foot amortization, and the least reliable positions are near the head and in the hands due to whole backbone amortization.

As described in paragraph [0030], there is a challenge in setting low and high thresholds because the system can fail to recognize similar curves/motions or can be misled into making “false positives” by shaking or tapping and so forth. However, by using a longer period of time and analyzing a longer sequence of data, the system can more precisely determine whether the detected motion comprises a series of steps or simply irregular movements made by a user standing or sitting and remaining generally in the same place.

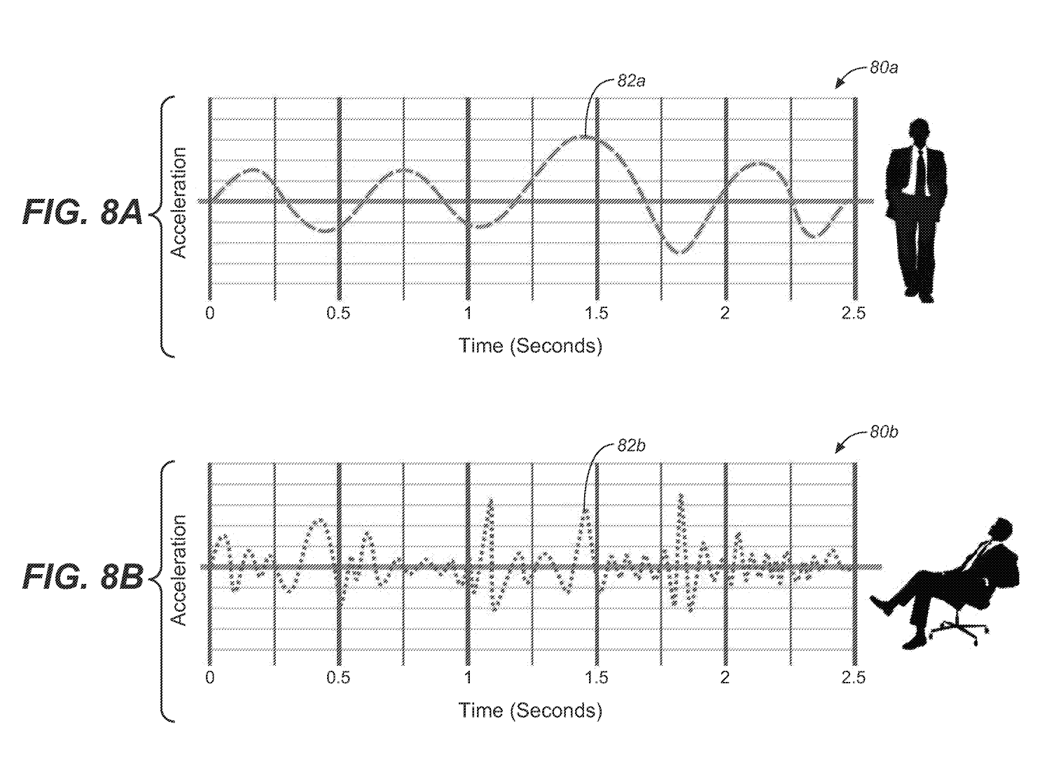

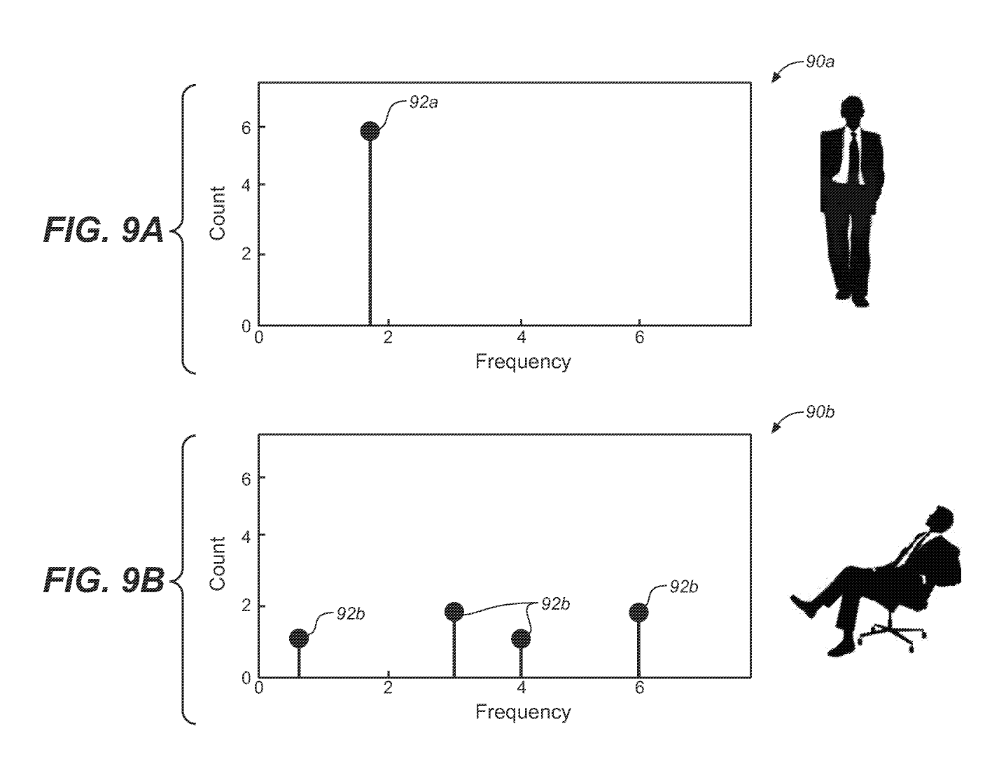

FIGS. 8A and 8B are schematic graphs 80a, 80b, respectively, showing waveforms for sensor detected walking motions 82a (FIG. 8A) and foot wagging 82b (FIG. 8B). FIGS. 9A and 9B are graphs 90a, 90b, showing the waveforms 92a, 92b, respectively, with a band-pass filter applied to make a frequency analysis for frequencies ranging around 1.5 Hz to 2 Hz. This provides an initial global analysis.

A second feature is to find the distance between sequences of steps and pattern (a global analysis) rather than finding distances between each local step and pattern (local analysis/pattern matching). Thus, there is accomplished a second global analysis.

The minimum length of a sequence used for such a comparison can vary in the number of steps and can be specified by the user via the user interface. However, if the system determines too few “potential” steps, it duplicates the steps as many times as necessary to create a sequence of the specified length.

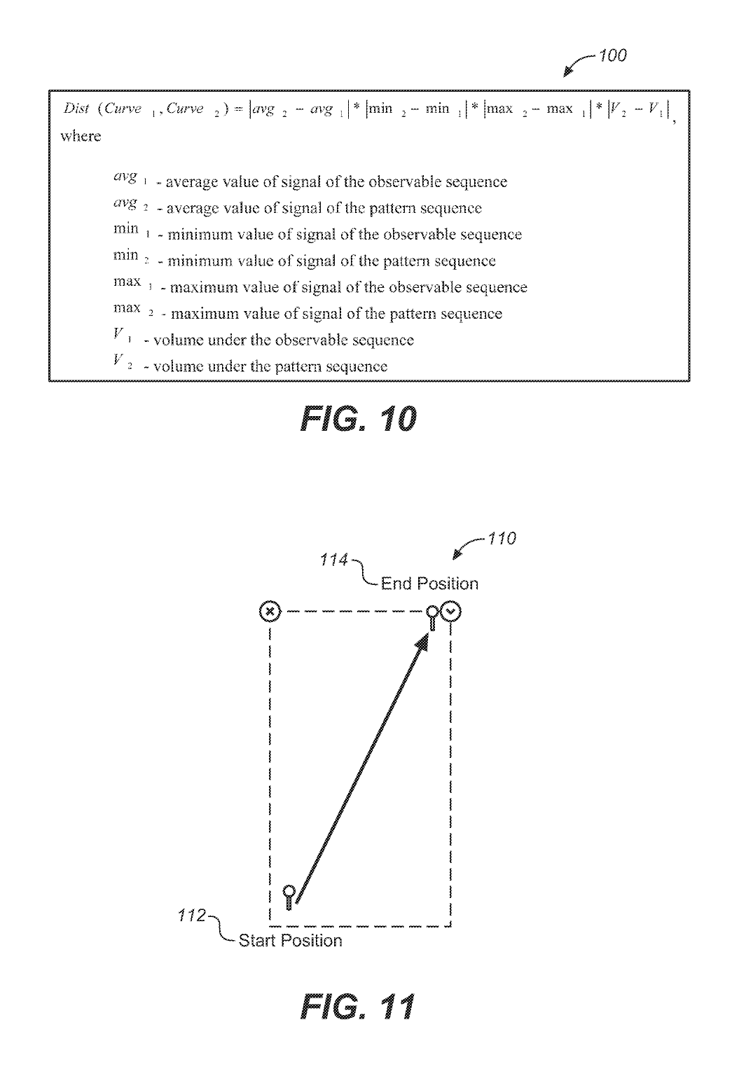

As an example, the system may identify three potential steps. The user, however, may have specified a sequence of seven steps. To compare the sequence of pattern steps and the sequence of given potential steps, the program concatenates the sensor data multiple times (three, for instance). The system then compares the distance between the two sequences using the formula 100 illustrated in FIG. 10.

As noted above, the sensor position system of the present invention uses device sensors such as a pedometer, magnetic compass, magnetometer, accelerometer, and so forth, to determine a user's position relative to a starting point. Experiments show that the stride length varies from person to person. Thus, the system does not assume a constant stride length and instead adapts it to each particular user using the calculation described herein.

Referring now to FIG. 11, there is shown in highly schematic form a visual display of an area drawing 110 with which to calculate a user's stride length. The stride length of a particular person is calculated using the following steps: (1) a schematic drawing is loaded into the device; (2) the user defines his/her current (start) position in the drawing 112; (3) the user makes several steps in one direction; (4) the user defines his/her new (end) position in the drawing 114; (5) the program determines L, N, where N=count of steps, L=route length in drawing units; and (6) The program calculates the user's stride length in drawing units using formula:

$$d = \frac{L}{N}$$

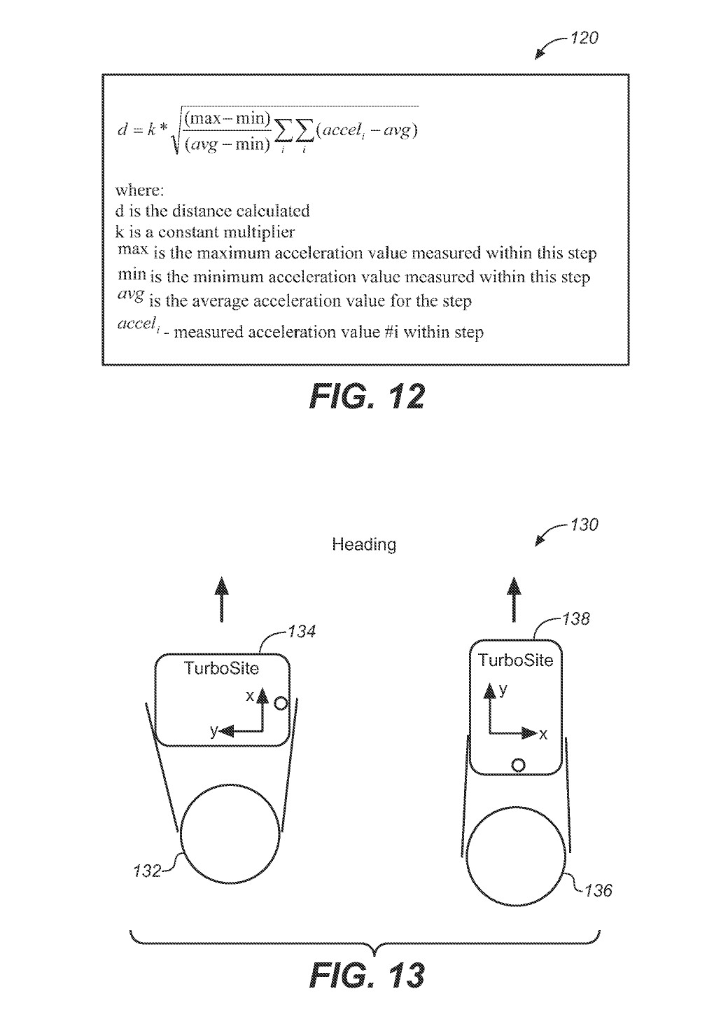

Using only an average stride length leads to low accuracy due to accumulating errors (residuals) between true step length and average length over time. An individual's stride length can vary by as much as ±50%. Knowledge of the actual stride length can reduce error. Thus, the sensor position system of the present invention uses an empirical formula 120 for use in improving the accuracy of a pedometer using a single accelerometer, such as that shown in FIG. 12.

Direction determination is also an important feature of personal navigation. The sensor position system of the present invention tracks the user's position by adding a vector to the previous position. Calculating the length of the vector is described above in paragraphs [0043] and [0044]. Referring now to FIGS. 13-16, there is shown a method for finding a vector for the direction of movement.

Direction calculations require that the user keep the device in one of four possible orientations: (1) portrait; (2) landscape left; (3) portrait upside down; or 4) landscape right. FIG. 13 shows two users, a first 132 holding a device 134 in a landscape orientation; and a second 136 holding a device 138 in a portrait orientation.

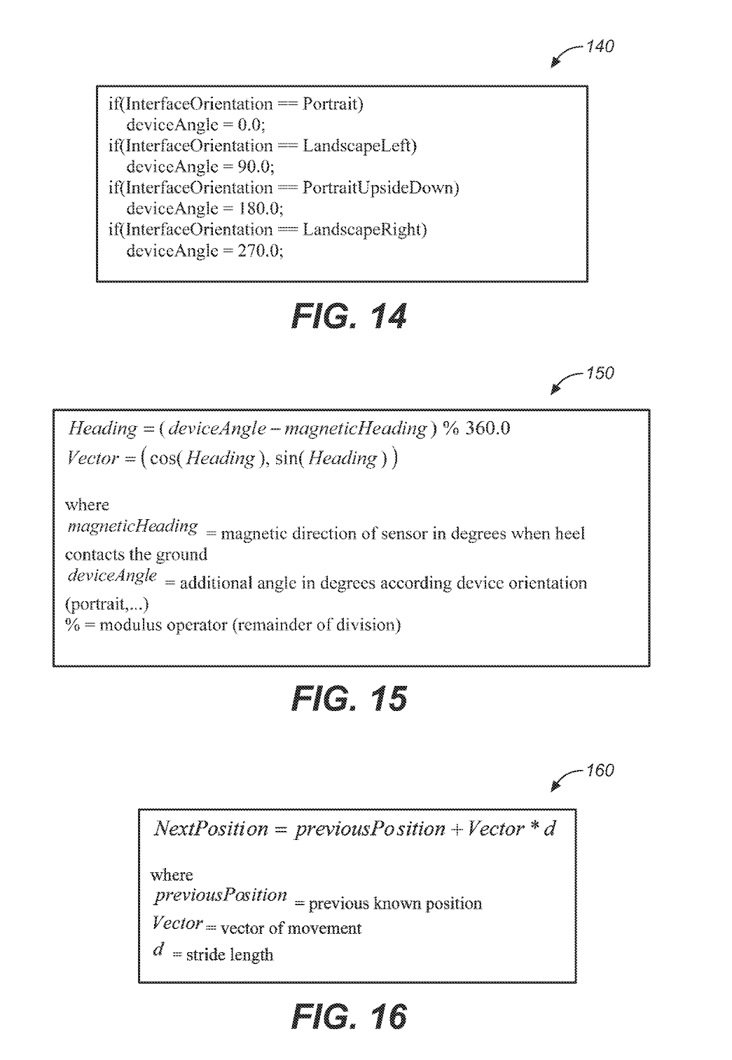

Using the fixed orientation, the system calculates and defines a device start angle according to the actual orientation in view of the four possible orientations 140 (see FIG. 14).

As the user begins to move, the system calculates the heading and direction vector using the formula 150 set out in FIG. 15. At this point, all of the parameters needed to calculate motion direction are acquired, i.e., previous position, stride length, and direction vector. Thus, the system can track the user position as he/she moves using the formula 160 set out in FIG. 16.

As noted above, there is an important determination to make in setting the optimal thresholds for step detection and identification, as a low threshold will miss true steps, and a high threshold will be prone to false positives. The effect is that a user's calculated position can drift on a drawing even though the user may be remaining in one place. This is the problem of drift.

To eliminate the problem of drift, the sensor position system preferably detects magnetic field anomalies by collecting and processing data from sensors, such as a three-axis magnetometer, and by storing the current position of the location marker on the drawing. When the device detects potential movement, if the magnetometer values detected are the same as those previously stored, drift is eliminated by moving the location marker back to the saved position.

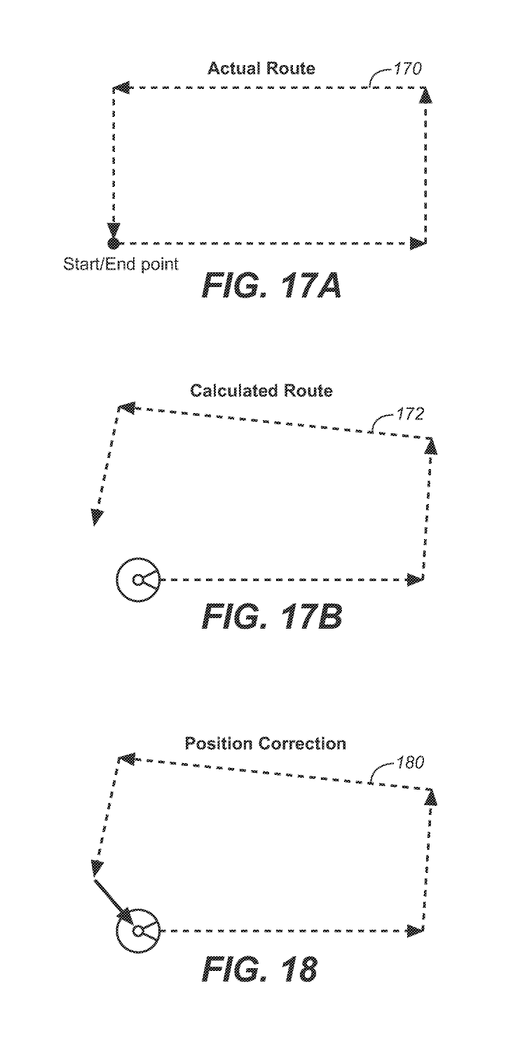

Another problem that must be addressed, and which is addressed in the present invention, involves the problem of positioning errors over time. Using sensors such as non-precise pedometer or compass leads to positioning errors with the lapse of time. At times the system may determine false movements, and at times it may fail to determine true steps. Errors in heading thus tend to accumulate. An actual route 170 (FIG. 17A) may thus be inaccurately and erroneously depicted in a calculated route 172 (FIG. 17B).

To fix the position, the system collects and processes data from a sensor, such as a three-axis magnetometer, and compares it to the current position of the location marker on drawing. In effect, it creates a “dynamic map” with values from the magnetometer linked to drawing coordinates. Then after the magnetometer detects the same values of a magnetic field as were previously stored, the system eliminates the error by moving the location marker back to its previously saved position 180 (see FIG. 18).

Other novel features which are characteristic of the invention, as to organization and method of operation, together with further objects and advantages thereof will be better understood from the following description considered in connection with the accompanying drawing, in which preferred embodiments of the invention are illustrated by way of example. It is to be expressly understood, however, that the drawing is for illustration and description only and is not intended as a definition of the limits of the invention. The various features of novelty which characterize the invention are pointed out with particularity in the claims annexed to and forming part of this disclosure. The invention resides not in any one of these features taken alone, but rather in the particular combination of all of its structures for the functions specified.

The foregoing disclosure is sufficient to enable those with skill in the relevant art to practice the invention without undue experimentation. The disclosure further provides the best mode of practicing the invention now contemplated by the inventor.

While the particular sensor positioning system and method herein shown and disclosed in detail is fully capable of attaining the objects and providing the advantages stated herein, it is to be understood that it is merely illustrative of the presently preferred embodiment of the invention and that no limitations are intended to the detail of construction or design herein shown other than as defined in the appended claims. Accordingly, the proper scope of the present invention should be determined only by the broadest interpretation of the appended claims so as to encompass all such modifications as well as all relationships equivalent to those illustrated in the drawings and described in the specification.

What is claimed as invention is:

1. A sensor position system, comprising:
a portable programmable electronic device having a visual display screen and at least one motion sensor; and
an executable sensor position system program loaded onto said electronic device, said program including executable instructions which visually display a two- or three-dimensional virtual representation of a user-selected physical space on the electronic visual display, enable a user to mark an initial reference point in the displayed virtual representation of the physical space, receive a data signal from said at least one motion sensor, evaluate the data signal from said at least one motion sensor so as to distinguish walking and running movements from other movements, and when the movement is determined to be a walking or running movement that moves the electronic device from the initial reference point to a new point within the physical space, causes the electronic data device to calculate the direction and distance traveled by the user and to display an end reference point in the virtual representation of the physical space;
wherein data from electronic positioning systems physically independent from said electronic device are not used.

2. The system of claim 1, wherein the at least one motion sensor is selected from the group consisting of accelerometer, gyroscope, magnetometer, orientation sensor, or any combination thereof.

3. The system of claim 1, further including a low-pass filter with a frequency cutoff of 3 Hz.

4. The system of claim 3, further including a high-pass filter with a frequency cutoff of 1 Hz.

5. The system of claim 1, further including a high-pass filter with a frequency cutoff of 1 Hz.

6. The system of claim 1, further including a bandpass filter having a low-pass cutoff of 3 Hz and a high-pass cutoff of 1 Hz.

7. The system of claim 1, wherein said system uses a combination of a constant threshold and an adaptive dynamic threshold responsive to the data signal from said at least one motion sensors passing the constant thresholds to produce a filtered signal.

8. The system of claim 7, wherein said system uses said filtered signal to make a potential step determination that differentiates user actions detectable by said at least one motion sensors between those signifying user ambulation movements of said electronic device from one location to another location within the physical space and those in which said at least one motion sensor detects motion not involving movement from one location to another within the physical space.

9. The system of claim 8, wherein said system determines the electronic device user's stride length.

10. The system of claim 9, wherein said system determines the direction in which the user is moving within the physical space.

11. The system of claim 8, wherein said potential step determination analyzes said filtered signal to determine whether it possesses the characteristics of an actual step.

12. The system of claim 11, wherein said system localizes the potential step by identifying waveforms that may indicate a walking or running step by the user.

13. The system of claim 12, wherein the system localizes the potential step by locating the left and right borders of a wave that may have been produced by a heel strike, extracts the parameters of the wave, including minimum value, maximum value, mean value, integral, and width of the wave, and saves the extracted data as step statistics.

14. The system of claim 13, wherein the system compares different wave patterns and step statistics, employs a distance function based on the step statistics extracted, and employs pattern matching to determine whether the potential step is a recognized step.

15. The system of claim 14, wherein the minimum length of a signal sequence used for pattern matching can vary in the number of steps and can be specified by the user.

16. The system of claim 15, wherein when said system determines too few potential steps, it duplicates the steps as necessary to create a sequence of the specified length.

17. The system of claim 8, further including means for users to tune the sensitivity threshold for distinguishing actual steps from non-ambulation movements.

18. The system of claim 17, further including pre-recorded patterns for users of different weights.

19. The system of claim 17, further including means for a user to record his or her personal step patterns.

20. The system of claim 17, wherein said sensor position program localizes each step within said data from said at least one motion sensor and compares it to the pattern step using the distance function.

21. The system of claim 1, wherein said sensor position program includes an algorithm to filter and separate frequency bands characteristic of heel strikes from the broader range of mixed signals, wherein false (non-actual) step motions can be distinguished from true steps.

22. The system of claim 1, wherein said system calculates the user's stride length.

23. The system of claim 1, further including a device orientation sensor, and wherein said system uses the orientation of the device to defines a device start angle, such that when a user begins to move, the system calculates the heading and direction vector of the user's movement.

24. The system of claim 1, wherein said sensor position system detects magnetic field anomalies by collecting and processing data from said at least one motion sensor and storing the initial position of a location marker on the virtual representation of the user-selected physical space, and wherein when said electronic device detects potential movement, if the values from said at least one motion sensor are the same as those stored as an initial location, said system eliminates drift problems by moving the location marker back to the initial position.
